(19) United States
(12) Patent Application Publication
(10) Pub. No.: US 2025/0339779 A1
(43) Pub. Date: Nov. 6, 2025

(54) E-SPORT SYSTEM WITH REFEREE ASSISTANCE

(71) Applicant: ACEZONE APS, Frederiksberg (DK)

(72) Inventors: Søren Louis PEDERSEN, Aarhus C (DK); Christian POULSEN, København V (DK)

(21) Appl. No.: 18/866,278

(22) PCT Filed: May 16, 2023
(86) PCT No.: PCT/EP2023/063153

§ 371 Date: Nov. 15, 2024

(30) Foreign Application Priority Data
May 17, 2022 (DK) PA202270260

(51) Int. Cl. A63F 13/75; A63F 13/215; G10L 21/0208

(52) U.S. Cl. CPC A63F 13/75; A63F 13/215; G10L 21/0208; A63F 2300/535

(57) ABSTRACT

An e-sport system for assisting an e-sport or gaming referee in detecting errors and attempts to cheat during an e-sport or gaming event. The system comprises gaming headset systems each comprising a headset to be worn by a gamer (GM), each headset having two ear cups each with a loudspeaker unit inside, an internal microphone inside at least one of the ear cups, and a mouth microphone serving to capture speech from the gamer wearing the headset. An ambient noise and speech suppression system (ANSS) serves to attenuate and suppress intelligibility of ambient speech sound reaching the gamer (GM) when wearing the headset, such as speech from the audience (AUD) or game commentator. The system further comprises a referee system (CNS) connected to the gaming headset systems. The referee system (CNS) is configured to monitor at least two parameters of a functional status, preferably an audio functionality status, for each of the plurality of gaming headset systems. The referee system (CNS) is generates a visual output, such as via a display, to notify the referee about the functional status of each of the plurality of gaming headset systems in response to said monitored parameters. This facilitates the task of the referee in identifying errors and attempts to cheat by the gamers, both which may potentially influence the outcome of the game.

### FIELD OF THE INVENTION

The present invention relates to the field of equipment suitable for gaming competitions and e-sport events, such as gaming or e-sport tournaments with a plurality of gamers e.g. competing in teams of a plurality of gamers. More specifically, the invention relates to an e-sport system with assistance to a referee of the e-sport competition in detecting and diagnosing attempt on fraud or cheating of the gamers with respect to hear comments from an audience present or of a game commentator, i.e. speech that can potentially provide an advantage to a gamer which should be detected by the game referee.

### BACKGROUND OF THE INVENTION

For gaming or e-sport events or tournaments, it is crucial with headsets having optimal suppression of noise from the surroundings, especially speech or shouts from the audience or speech from a speaker commenting the game (game commentator). Ideally, the gamers should only hear the game sound and inter-communication with their team members. Otherwise, gamers may hear words from the surroundings which can be helpful for the gamers to perform tasks in the game. Such help from outside can be treated as fraud or cheating in the game and potentially, such cheat or fraud can influence the game, and thus the game referee should detect such attempts to cheat and punish the gamer or the team of gamers trying to cheat.

However, the role of the game referee in detecting such attempts to cheat is difficult in a hectic and loud e-sport game situation with an audience and a game commentator and e.g. two teams with 4-6 gamers each. This means that the referee may be left in situations where one of the gamers might have had access to speech from outside which can influence the result of the game without the referee being able to detect such fraud or cheat.

The fraud or cheat problem can destroy an e-sport event in case it is not detected, and e.g. a game has a wrong winner based on undetected information from the audience or other source being caught by one or more of the involved gamers.

### SUMMARY OF THE INVENTION

Thus, according to the above description, it is an object of the present invention to provide an e-sport system that can assist a referee of an e-sport game or event in detecting and possibly diagnosing fraud or cheat.

In a first aspect, the invention provides an e-sport system comprising
a plurality of gaming headset systems each comprising
   a headset to be worn by a gamer, wherein the headset comprises right and left ear cups each with a loudspeaker unit inside, an internal microphone inside at least one of the ear cups, and a mouth microphone serving to capture speech from the gamer wearing the headset, optionally also a feedforward microphone outside at least one of the ear cups, and
   an ambient noise and speech suppression system arranged to attenuate and suppress intelligibility of ambient speech sound reaching the gamer when wearing the headset, and
a referee system arranged for connection to the plurality of gaming headset systems,
   wherein the referee system is configured to monitor at least two parameters of a functional status for each of the plurality of gaming headset systems, and
   wherein the referee system is configured to generate a visual output, optionally also an audible output, configured to notify a referee of an e-sport event about the functional status, such as an audio functional status, of each of the plurality of gaming headset systems in response to said monitored at least two parameters for each of the plurality of gaming headsets.

Such e-sport system is advantageous, since the game referee is provided with a tool which can monitor the status of the function of the gaming headsets of all gamers and provide a visual output to the referee accordingly. Especially, it is preferred to monitor two or three parameters of a status of audio function of each of the gaming headset systems. Hereby, the referee can be continuously updated of the function of all the gamer's gaming headsets during a game, and the referee can detect technical errors and/or attempts to cheat by hearing external sound, such as a gamer misplacing the headset ear cup so the gamer can hear informative speech from the audience of game commentator.

The e-sport system can assist the referee in the complicated task of ensuring that none of the gamers can cheat by gaining access to external speech from the audience or game commentator which may include game important information, and which in turn can be crucial for the outcome of the game. Furthermore, the e-sport system can prompt the referee of technical problems relating to the headsets, such as: missing game sound, a broken mouth microphone, or non-function of the ambient noise and speech suppression system. Such technical problems may also be crucial for the game, and thus important for the referee to notice and handle appropriately.

The referee system can be configured to determine if one or more parameters of the functional status for one gamer's gaming headset system is within an acceptable predetermined limit or not based on signals received from, and e.g. also transmitted to, the gaming headset systems. This may involve that the referee system processes audio signals from or to the gaming headset systems via the connection to the referee system, and by means of the processing, the referee system determines a parameter of an audio functional status of each of the gaming headset systems. It may also, or alternatively, involve the gaming headset systems transmitting non-audio data or signals via their connection to the referee system to inform the referee system about measured values and/or detected errors which are determined by each individual gaming headset system itself.

As an example, the gaming headset systems may be configured to measure effective acoustic insertion loss for at least one of the ear cups and to transmit a value to the referee system accordingly, and the referee system can then compare the measured effective acoustic insertion loss with a predetermined threshold or limit and thereby determine if it is likely that there is an attempt to cheat, e.g. by a gamer misplacing the ear cup. The referee system can then generate a visual output to the referee to draw attention to such possible attempt to cheat. With such continuously updated functional status information presented with a visual overview, the referee can decide to take action accordingly, e.g. pause the game in case an attempt to cheat is detected, and/or give a penalty to one gamer or the cheating gamer's team.

In some embodiments, the referee system can be configured to record sound heard by the gamers, e.g. sound captured by a microphone inside the ear cup(s) of the gaming headsets. The referee can thus playback what a gamer was hearing at a specific period of time, and the referee can then decide a suitable action accordingly, e.g. based on a decision whether the gamer actually heard important information from outside which could give the gamer an unreasonable advantage and thus should be judged by the referee.

In some embodiments the gaming headset system can determine their functional status and transmit the functional status to the referee system, either in a wired or wireless connection. In other embodiments, the referee system can at least partly detect the functional status of the gaming headset systems based on audio data received from, and/or audio data transmitted to, the gaming headset systems in wired or wireless form.

In some embodiments, the referee system can present the referee with an overview display with icons presenting all gamers of a game, and with indications if any of the monitored functional parameters of the gaming headsets exhibit any abnormal character or error. This may be indicated with colors and/or any dynamic visual affect and/or an audible effect with the purpose of drawing the referee's attention towards any erroneous or abnormal behavior of one of the gamers.

In the following preferred features and embodiments of the first aspect will be described.

Preferably, the gaming headset system is designed to allow a high degree of suppression of speech sounds present during e-sport event or game where gamers are supposed not to hear nor to understand any speech from the surroundings in spite of loud speech or shouts from an audience and a game speaker (game commentator) commenting the game via PA loudspeakers. In some embodiments, the gaming headset systems have an ambient noise and speech suppression (ANSS) system comprising an active noise cancellation (ANC) system, such as a feedback or a feed forward based ANC system or a combination of both a feedback and a feed forward ANC system. The ANSS system may further comprise a masking noise generation system which generates a masking noise signal which is played back in the loudspeaker units of the ear cups, so as to mask any external speech sound from being intelligible for the gamer. Furthermore, the headset ear cups are preferably over-the-ear ear cups to provide a high passive acoustic insertion loss of at least 10 dB within 300-3,400 Hz, e.g. at least 20 dB within 300-3,400 Hz. By passive acoustic insertion loss of at least X dB within 300-3,400 Hz is understood a passive acoustic insertion loss which is not below X dB in any ⅓ octave frequency band within 300-3,400 Hz.

Game sound for each individual gamers may be sound generated by a game computer executing the game. Furthermore, mouth microphone signals are distributed to team members's gaming headset system, to allow the team members to communicate. Both the game sound and the mouth microphone signals may be provided to the referee system, e.g. to allow the referee to select to hear team member's communication and/or game sound as heard of a specific gamer.

In some embodiments, the ANSS system of the gaming headset systems are arranged to determine a measure of effective acoustic insertion loss. This can be done within a suitable time interval, sound energy captured within a predetermined limited frequency range by use of a feed forward microphone and a feedback microphone of an ANC system of the gaming headset system. Especially, the ANSS system may be arranged to compare said measure of effective acoustic insertion loss with a predetermined criterion and to generate an output signal indicative thereof to the referee system. This measure can especially be determined continuously or at regular time intervals and be used during a game event as a measure of revealing any attempts by a gamer to cheat by providing a leak to the surroundings to hear possible helpful messages from the audience. If the effective acoustic insertion loss is compared e.g. to a predetermined fixed minimum value, it can be considered as a leak, and thus possible cheating, if the effective acoustic insertion loss is determined to be below the fixed minimum value, and the headset system may then generate a warning or an alarm, e.g. to a referee of the game, allowing the referee to take action accordingly—e.g. stop the game, or inform the gamer to correct the headset etc. Specifically, the gaming headset system may comprise a light indicator placed on a visible exterior part of the headset to indicate in case said measure of effective acoustic insertion loss meets the predetermined criterion. This may help a referee to detect possible cheating by a gamer creating sound leaks to hear sound from the audience etc. in addition to a further visual output on a display to warn the referee of a possible cheating situation.

A light indicator may be placed on a visible exterior part of the headset, e.g. to indicate in case the game sound is reproduced by the loudspeaker units or not. A light indicator may be placed on a visible exterior part of the headset to indicate is the mouth microphone is functioning or not. A light indicator may be placed on a visible exterior part of the headset to indicate if the ANSS system is in function or not. The gaming headset system may be configured to transmit a data signal to the referee system indicative of one or more of such mentioned functional parameters determined by the gaming headset system, and the referee system can then collect such functional data from all of the gaming headset systems and generate a visual overview accordingly to the referee, e.g. on a display using symbols and/or colours and/or text messages.

The referee system or the gaming headset system may be configured to detect any unbalance in audio level in the left and right ear cup. Especially, this may be indicated with a light indicator on a visible exterior part of the headset and/or communicated to the referee system. The referee system may be configured to provide a visual output of such unbalance in audio level to the referee, e.g. in case the unbalance exceeds a predetermined limit, such as 5 dB, 10 dB or the like.

The referee system may comprise a console with a connection interface for wired or wireless connection of all of the gaming headset systems, i.e. including audio signals in analog and/or digital format, and e.g. data signals from the gaming headset systems for communicating data to the referee system to be used by the referee system in the monitoring of functional status of each individual gaming headset system.

The referee system may comprise a microphone input and a referee microphone connected to the input to allow the referee to communicate with one or more of the gamers. Especially, the referee system may comprise a user interface to allow the referee to select to speak to: 1) a selected one of the gamers, 2) a selected team of gamers, 3) or all gamers.

The referee system may comprise an audio output and a user interface to allow the referee to select to hear audio from 1) a selected one of the gamers, 2) a selected team of gamers, 3) or all gamers. The user interface may allow the referee to select to hear audio from the internal microphone or the mouth microphone. Especially, by selecting to hear audio from the internal microphone of a specific gamer, the referee can hear what the gamer actually hears, and thus the referee can decide if the sound heard by the gamer in case of a leak by one ear cup may include important speech from the game commentator or the audience, so as to judge whether the gamer has received information influencing the game.

The referee system may be configured to output sound captured by one or more microphones of one or more of the gaming headset systems. This may be used by the game referee to check and listen, or a TV transmission or internet streaming to transmit sound as it is heard by one or more of the gamers in an e-sport event, i.e. the same way as images and sound transmitted from the interior of a racing car to provide the feeling of the spectator to sit in the racing car during a race etc.

The referee system may comprise a computer, e.g. a stand-alone computer or a computer built into a dedicated referee console with a suitable user interface to allow the referee to change the visual output to show various details or overviews. Further, such user interface may allow the referee to easily select to hear audio from one of the gaming headset systems microphones, and/or game sound. A user interface of the referee system may allow the referee to playback recorded data and/or audio at a selected period back in time, so as to allow the referee to judge if any attempt to cheat or if any technical problem has influenced the game. The referee system may provide a visual output on a display and provide also a Graphical User Interface to allow the referee to navigate through various functions of the referee system.

The referee system may be configured to monitor a parameter indicative of function of the mouth microphone for each of the plurality of gaming headset systems.

The referee system may be configured to monitor a parameter indicative of a function of the ambient noise and speech suppression system (ANSS) for each of the plurality of gaming headset systems.

The referee system may be configured to monitor a parameter indicative of whether game sound is present in the headset, such as present in both right and left ear cups of the headset, for each of the plurality of gaming headset systems.

The referee system may be configured to monitor a parameter indicative of an audio level unbalance between right and left ear cups of the headset, for each of the plurality of gaming headset systems.

The referee system is preferably configured to monitor at least three parameters of a functional status for each of the plurality of gaming headset systems. Especially, the referee system may be configured to monitor all of: 1) a parameter indicative of function of the mouth microphone for each of the plurality of gaming headset systems, 2) a function of the ambient noise and speech suppression system (ANSS) for each of the plurality of gaming headset systems, and 3) a parameter indicative of whether game sound is present in the headset, such as present in both ear cups of the headset, for each of the plurality of gaming headset systems. Especially, each of the gaming headset systems comprises at least one light indicator visible from outside and which is indicative of at least one of: 1), 2) and 3), more specifically each of the gaming headset systems comprises a plurality of light indicators visible from outside and which are indicative of all of: 1), 2) and 3).

The referee system may be configured to generate a visual output comprising a graphical representation indicative of at least one of: 1), 2) and 3) for all of the gaming headset systems, such as in one single overview. Especially, the referee system is configured to generate a visual output comprising a graphical representation indicative of all of: 1), 2) and 3) for all of the gaming headset systems, such as in one single overview. Especially, a functional status of each of the gaming headset systems is indicated graphically on the graphical representation, so as to indicate to the referee if a function of one or more parameters of one of the gaming headset systems requires attention, such as by indication of a red color in case one of the gaming headset systems requires attention due to an unacceptable function of at least one of the monitored parameters. Especially, the referee system may be configured to general a visual output in which a functional status of each of the gaming headset systems involved in the game is indicated as respective symbols on one single graphical representation, and wherein a color of each symbol indicates if a functional status of the corresponding gaming headset system is acceptable or not, such as a green color indicating an acceptable functional status and a red color indicating an unacceptable functional status.

The referee system may be configured to notify the referee if each of the plurality of gaming headset systems is functioning properly, by determining, if each of the at least two parameters fulfil predetermined test criteria.

The referee system may be configured to notify the referee if one of the plurality of gaming headset systems is not functioning properly, based on testing at least two parameters against predetermined test criteria. Especially, the referee system may be configured to notify the referee which one or more of the plurality of gaming headset systems is not functioning properly, in case it is determined that one or more of the plurality of gaming headset systems is not functioning properly.

The referee system may comprise an audio output to allow the referee to hear audio captured by a microphone of a selective one of the gaming headset systems.

The referee system may be configured to record or store audio captured by a microphone of a plurality of, such as each of, the gaming headset systems, so as to allow the referee to later playback audio stored or recorded. Especially, the referee system may be configured to enable playback of the recorded or stored audio from a selected one of the gaming headset systems. Especially, the referee system may be configured to enable playback of the recorded or stored audio at a selected time period from the selected one of the gaming headset systems. Especially, the referee system may be configured to record or store audio captured by a the internal microphone or feedback microphone forming part of the ambient noise and speech suppression system (ANSS) of a plurality of, such as each of, the gaming headset systems. This will allow the referee to playback the sound that a gamer actually heard back in time, thereby allowing the referee to decide an action in case of cheat.

The referee system may be configured to receive audio inputs from the plurality of gaming headset systems and to determine at least two parameters of a functional status for each of the plurality of gaming headset systems by processing the audio inputs from the respective gaming headset systems according to a predetermined algorithm.

The referee system may be configured to monitor observe at least two parameters of a functional status for each of the plurality of gaming headset systems by receiving signals indicative of respective at least two parameter values determined at the respective gaming headset systems. Especially, each of the gaming headset systems may comprise a processor configured to execute a control algorithm arranged to determine a value indicative of effective acoustic insertion loss of the headset, and wherein each of the gaming headset systems is configured to transmit said value to the referee system.

The referee system may be configured to determine a value indicative of effective acoustic insertion loss of the headset of each of the gaming headset systems. Especially, the referee system may be configured to determine the value indicative of effective acoustic insertion loss, for each of the gaming headset systems, based on an audio signal indicative of sound captured by an internal microphone and on an audio signal indicative of sound captured by a microphone positioned external to the ear cups. Especially, the referee system may be configured to determine, for each of the gaming headset systems, if the value indicative of the measured effective acoustic insertion loss is below a predetermined threshold level, such as below a value within 10-40 dB, and to provide a visual indication to the referee in case said value for one or more of the gaming headset systems is below the predetermined threshold level.

Each of the gaming headset systems may comprise an active noise cancellation system, and wherein each of the gaming headset systems is configured to transmit a signal indicative of a function of the active noise cancellation (ANC) system to the referee system, e.g. a signal indicative of whether the ANC system is functioning or not. Especially, the referee system may be configured to generate a visual output in response to received signals indicative of functions of the active noise cancellation system of the gaming headset systems, such as a visual indication in case one or more of the received signals indicative of functions of the active noise cancellation system of the gaming headset systems is out of function.

The referee system preferably comprises
a processor configured to execute a control algorithm,
a display arranged to notify the referee about the functional status of each of the plurality of gaming headset systems, and
a user interface configured to allow the referee to control a function of the referee system.

The referee system may be configured to allow the referee to send an audio message to one or more selected ones of the gaming headset systems, so as to allow the referee to send information to one or more of the gamers.

The referee system may be configured to monitor if an audio level unbalance between right and left exceeds a predetermined threshold for one or more of the gaming headset systems, and to cause an action accordingly.

The referee system may comprise a camera, such as a camera configured to generate an image of one or more of the gamers, such as a camera configured to generate an image of the gamers and environments around the gamers. Especially, the referee system may be configured to notify the referee about one or more functionalities of the gaming headset systems based on the image received from the camera. Specifically, the referee system may be configured to notify the referee about at least one of: a) a position of the mouth microphone relative to the gamer's mouth, and b) a position of the ear cups of the head set on the gamer's head, based on the image received from the camera. Specifically, the referee system may be configured to notify the referee of an attempt to provide visual information to one or more of the gamers, based on the image received from the camera. Especially, the referee system may be configured to process the image received from the camera and to process the image according to an image processing algorithm, such as to generate a visual notification to the referee in response to an output of the image processing algorithm, such as the image processing algorithm being configure to identify one or more errors and/or an attempt to cheat.

The referee system may be configured to receive game audio from a computer system arranged to execute a game, such as respective game audio signals to be transmitted to the respective gaming headset systems for playback to the individual gamers during the game. This will allow the referee to select to hear audio transmitted to a selected on of the gamers, if preferred.

In some embodiments, each of the gaming head systems comprises an ambient noise and speech suppression system (ANSS) comprising a processor system arranged to execute an active noise cancellation algorithm part (ANC) and a masking noise signal algorithm part (MSK) arranged to add a masking noise signal to the loudspeaker units of the right and left ear cup of the headset, so as to provide a psychoacoustic masking effect of speech sound to limit the gamer's intelligibility of any speech from an external source, such as speech sound from a game commentator (GSP) and/or speech sound from the audience (AUD).

It is to be understood that the referee system may comprise a dedicated hardware with a processor and being designed specifically e.g. with a physical user interface and e.g. a display integrated and e.g. a physical connection interface for wired or wireless connection to the gaming headset systems. However, the referee system may alternatively be implemented based on a general computer system and a display.

In some embodiments, the referee system is configured to execute a referee assisting algorithm, such as an artificial intelligence based algorithm, configured to receive at least one signal from each of the gaming headset systems and to determine accordingly, for each of the gaming headset systems: either one of or both of: 1) if it likely that the headset is correctly placed and to initiate an action accordingly, and 2) if it likely that the gamer wearing the headset can hear sound that can be considered as cheat or fraud, wherein the referee assisting algorithm is configured to initiate an action accordingly. Especially, this action may comprise generating an audible or visible output, such as an audible and/or visible text message, however the action may involve pausing or interrupting the game in case it is determined an attempt to cheat or fraud is likely. Especially, the referee system is configured to receive at least one audio signal from each of the gaming headset system, and wherein said referee assisting algorithm is configured to process the audio signal from each of the gaming headset system. Such referee assisting algorithm can assist the referee in handling judgements during a game and can be see as an automatic or semi-automatic referee.

In a second aspect, the invention provides use of the e-sport system according to the first aspect, such as for an e-sport or gaming event or tournament.

In a third aspect, the invention provides a method for assisting a referee during an e-sport or a gaming event with a plurality of gamers, wherein each gamer has a gaming headset system for playing individual game audio signals to the gamers, the method comprising
providing a referee system connected to the gaming headset systems of all of the gamers,
monitoring at least two parameters, such as at least three parameters, of a functional status for each of the plurality of gaming headset systems by means of the referee system during the e-sport or gaming event, and
generating, by the referee system, a visual output, such as an output signal to a display, so as to notify the referee of the e-sport or game event about the functional status of each of the gaming headset systems during the e-sport or gaming event, in response to said monitored at least two parameters for each of the plurality of gaming headsets.

The method may comprise monitoring at least two parameters, such as at least three parameters, indicative of an acoustical or audio functional status of each of the plurality of gaming headset systems.

Preferably, the referee system comprises a processor configured to execute a control algorithm, and wherein the method comprises receiving signals from the gaming headset systems during the e-sport or game event, processing the signals received from the gaming headset systems by the control algorithm, and generating the visual output to notify the referee about the functional status of each of the gaming headset systems accordingly. Especially, the method may comprise processing audio signals from each of the gaming headset systems according to the control algorithm, and generating at least one parameter indicative of an acoustical functional status of each of the gaming headset systems accordingly. Especially, the method may comprise processing audio signals and at least one other data signal from each of the gaming headset systems according to the control algorithm, and generating at least one parameter indicative of an acoustical functional status of each of the gaming headset systems accordingly.

The method may comprise generating, by the referee system, a visual overview of the functional status of all of the gaming headset systems continuously during the e-sport or gaming event. Especially, the method may comprise generating a visual graphical indication, such as using a color and/or a symbol, in case a functional status of one of the gaming headset system is unacceptable.

The step of monitoring the at least two parameters, and the step of generating, by the referee system, the visual output may be continuously updated during an e-sport or gaming session, so as to ensure that the referee is supplied with updated functional status information.

The method may include receiving, by the referee system, audio data from the gaming headset system and storing said audio data. Especially, the method may comprise receiving, by the referee system, a user input, and playing back an audio signal based on said stored audio data in response to the user input.

In a fourth aspect, the invention provides a computer program product having instructions which when executed cause a computing device or a computing system with a processor to perform the method according to the third aspect.

Especially, the computer program product may be one of: an audio application, a digital audio workstation plug-in, and a stand-alone software product for a general computer. It is to be understood that the computer program product instructions in the form of program code which may be implemented on any type of audio processing platform, e.g. a sound card in a computer, a general processor in a mobile device e.g. in the form of a downloadable application for a programmable device. E.g. the computer program product may implement a GUI.

In a fifth aspect, the invention provides use of the method according to the third aspect, such as for an e-sport or gaming event or tournament.

It is appreciated that the same advantages and embodiments described for the first aspect apply as well for the second, third, fourth, fifth, sixth, and seventh aspects. Further, it is appreciated that the described embodiments can be intermixed in any way between all the mentioned aspects.

### BRIEF DESCRIPTION OF THE FIGURES

The invention will now be described in more detail with regard to the accompanying figures of which

FIG. 1 illustrates a block diagram of an e-sport system embodiment,

FIG. 2 illustrates a block diagram of an example of a gaming headset system connected to a referee system,

FIG. 3 illustrates an example of a visual output to be presented to the referee and indicating the overall function of the gaming headset systems for each gamer of each team,

FIG. 4 illustrates an example of a visual output to be presented to the referee with symbols and colours indicating three functional parameters for each ear cup of each gaming headset system of each gamer of one team,

FIG. 5 illustrates a possible layout of a set of light indicators for signalling functional status parameters of a gaming headset system, e.g. for position on an externally visible part of the headset, and

FIG. 6 illustrates steps of a method embodiment.

The figures illustrate specific ways of implementing the present invention and are not to be construed as being limiting to other possible embodiments falling within the scope of the attached claim set.

### DETAILED DESCRIPTION OF THE INVENTION

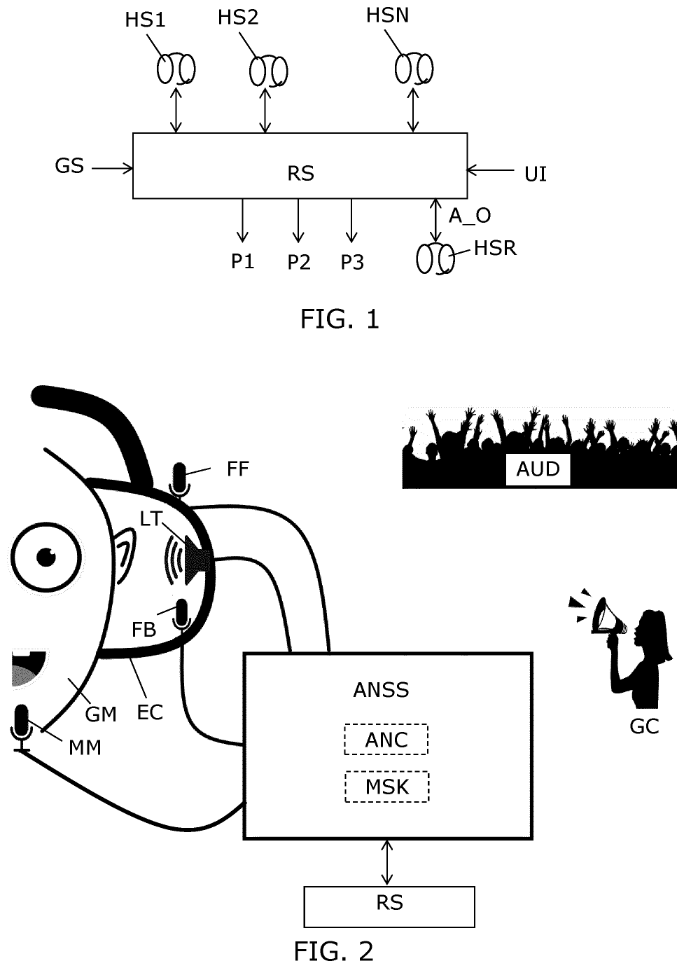

FIG. 1 shows a block diagram of an e-sport system embodiment with a plurality of gaming headset systems HS1, HS2, HSN connected to a referee system RS which has a user interface to receive a user input UI to allow the referee to control the function of the referee system RS, and which outputs a visual representation of three parameters P1, P2, P3 indicating a functional status of the gaming headset systems HS1, HS2, HSN, so as to allow a referee to receive updated functional information of the headsets of all gamers during a game. Preferably, at least two of the parameters P1, P2, P3 are indicative of audio functionality of the gaming headset systems HS1, HS2, HSN.

In the shown embodiments, game sound GS from the computer executing the game is input to the referee system RS which serves to distribute the game sound to the individual gaming headset systems HS1, HS2, HSN.

Each gaming headset systems HS1, HS2, HSN has a headset to be worn by a gamer. The headset has right and left ear cups each with a loudspeaker unit inside. An internal microphone is positioned inside at least one of the ear cups, and a mouth microphone serves to capture speech from the gamer wearing the headset. An ambient noise and speech suppression system (ANSS) arranged to attenuate and suppress intelligibility of ambient speech sound reaching the gamer when wearing the headset.

The referee system RS has a wireless or wired connection interface for connection to the gaming headset systems HS1, HS2, HSN. The referee system RS is configured to monitor three parameters P1, P2, P3 of a functional status for each of the plurality of gaming headset systems HS1, HS2, HSN. Especially, these may be: P1) a parameter indicative of function of the mouth microphone for each of the plurality of gaming headset systems, P2) a function of the ambient noise and speech suppression system (ANSS) for each of the plurality of gaming headset systems, and P3) a parameter indicative of whether game sound is present in the headset, such as present in both ear cups of the headset, for each of the plurality of gaming headset systems.

Especially, an effective acoustic insertion loss may be an additional audio functional parameter to be monitored, since this may indicate a gamer trying to hear external spoken information to help the gamer by misplacing one ear cup trying to generate an acoustic leak. Thus, measuring the effective acoustic insertion loss being below a predetermined limit, e.g. 10-20 dB, an indication of an error or an attempt to cheat has been detected.

The referee system RS is configured to generate a visual output, such as comprising a display, configured to notify a referee of an e-sport event about the functional status of each of the plurality of gaming headset systems in response to the monitored parameters P1, P2, P3 for each of the plurality of gaming headsets. This can be presented on an overview graphical representation on a display to the 25 referee. Especially, a specific symbol, colour or audible alarm may be provided to indicate to the referee in case a technical error or an attempt to cheat.

In the shown embodiment, the referee system RS further has an audio output A_O to a headset HSR to be worn by the referee. The referee can select via the user interface UI to hear the sound that one of the gamers hears, e.g. to hear communication between gamers on a team or to hear if the a gamer can hear audible messages from the audience that can be considered as cheating.

The referee system RS may record sound and e.g. other data e.g. the the functional parameters P1, P2, P3, so as to allow the referee to later playback sound from the game and gamers, e.g. to detect any cheating attempts.

FIG. 2 shows a block diagram of a gaming headset system embodiment (only one side of the headset is shown for simplicity). This is just an example of a specific gaming headset system, however in general the referee system RS can be used with many commercially known gaming headset systems.

In FIG. 2 a gamer GM wears a headset with a headphone and a mouth microphone MM, e.g. the mouth microphone MM has several separate microphones for beam forming. The headphone has two over-the-ear ear-cups EC. Inside each ear-cup EC a loudspeaker transducer LT and a feed-back microphone FB is located. One, or preferably several, feed-forward microphones FF are placed on an exterior part of each of the ear-cups EC. The ear-cups EC are preferably with airtight or at least substantially airtight ear pads so as to provide a passive acoustic insertion loss of at least 10 dB, preferably at least 15-20 dB within 300-3,400 Hz.

The function of the gaming headset is to allow the gamer GM to hear game sound GS, i.e. the sound of the computer generated as well as speech from the co-gamers' headsets mouth microphones. All ambient noise and speech should ideally be completely suppressed, so that the gamer GM is acoustically isolated from the surroundings.

An ambient noise and speech suppression system ANSS executes an ambient noise and speech suppression on a processor which comprises an ANC algorithm part ANC and a masking signal noise algorithm part MSK. This combination allows a high degree of ambient noise and speech suppression with a special focus on suppressing speech and speech intelligibility of speech from the surroundings that the gamer is not allowed to hear during a game, i.e. game commentator GC and audience AUD.

The ANSS system is connected to receive input from the feed-back microphones FB, input from the feed-forward microphones FF, and receive an input signal indicative of a game sound to be reproduced to the gamer GM, e.g. the game sound is a direct audio connection to the computer executing the game, or the game sound is applied to via the referee system RS (see FIG. 1). The ANSS provides output signals to the respective loudspeaker transducers LT in the ear-cups of the headphone in response to the ANC algorithm part ANC as well as the masking signal noise algorithm part MSK.

The ANC algorithm part preferably operates in a combined feed-back and feed-forward configuration including at least inputs from the feed-forward microphone FF and the feed-back microphones FB, so as to provide the output signals to the respective loudspeaker transducers LT for reproduction of the game sound GS to the gamer with an optimised suppression of ambient noise and speech sound, especially speech sound from the game speaker (game commentator) and speech sound from the audience.

Most preferably, several separate mouth microphones MM are used in combination with several feed-forward microphones FF distributed on each ear-cups EC, and wherein the ANC algorithm part ANC operates on all inputs from all mouth microphones and all feed-forward microphones FF to provide optimal suppression of speech sounds from the game commentator GC and the audience AUD.

ANC algorithms in general involving feed-forward and feed-back are known in the art. It is to be understood that the ANC algorithm part ANC is preferably implemented as a stereo version, i.e. separate for the right and left ear cup, to provide optimal use of the left set of FF and FB microphones to provide ANC to the left loudspeaker transducer LT and likewise for the right side, however a single channel ANC version may also be implemented if preferred.

The masking signal noise algorithm part MSK may generate a masking signal noise to be applied to the loudspeakers LT of the headset in response to an input comprising one or more of: 1) a signal from at least one of the feed-forward microphones FF, 2) a signal indicative of speech sound from a game commentator GC, and e.g. a signal indicative of speech sound from the audience AUD.

A psychoacoustic masking signal is preferably generated by the algorithm MSK that will destroy speech intelligibility of any remaining speech sound that may reach the ears of the gamer GM in spite a passive insertion loss of the ear-cups EC and the attenuation or suppression provided by the ANC algorithm part ANC. This masking noise signal may be generated according to known principles in the art of psychoacoustics. Especially, the masking noise signal may be generated as a scrambled version of the input signal, e.g. based on the signal or one or more of the feed-forward microphones FF. This has been found as an effective and relatively simple way of providing a masking noise signal that destroys speech intelligibility.

It may be preferred that the ambient noise and speech suppression system ANSS is capable of continuously or at regular time intervals measures the effective acoustic insertion loss IL of the headset, e.g. by comparing features of the sound captured by the feed-forward and feed-back microphones of the headset. Preferably, the loudspeaker in the ear cup is silent (switched off) when determining the effective acoustic insertion loss IL. This insertion loss value IL can then be transmitted as a functional parameter to the referee system, or the IL value can be applied to a decision algorithm comparing the insertion loss value IL with a predetermined insertion loss threshold, and an alarm signal can be generated in response to the insertion loss value IL being below the insertion loss threshold. Part of this, or all such effective acoustic insertion loss IL measurement and decision may be performed by the referee system, in case an audio connection to the gaming headset system includes all necessary audio signals to allow the referee system to perform the measurements and the decision. A visual and/or audible alarm to the referee can be generated if the IL value is below a predetermined threshold value, thereby indicating an attempt to cheat.

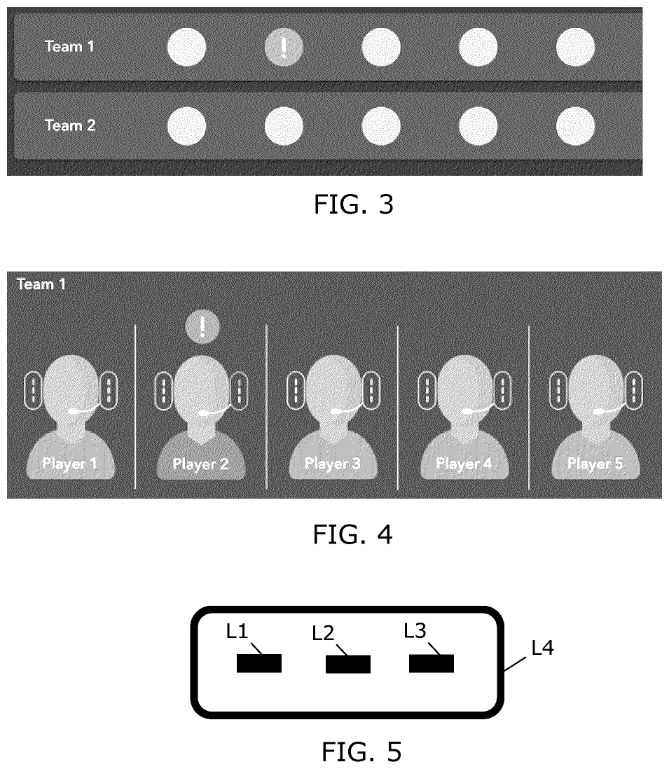

FIG. 3 shows an example of a graphical representation to be visually output on a display to the referee by the referee system showing an overview of a functional status of the gaming headset system of each of five gamers on each of two teams. The coloured circles indicate the status of each gamer's headset system, i.e. being OK (light colour) or not OK (grey color and indicated with a “!” symbol), thereby drawing the referee's attention to a potential problem.

FIG. 4 shows an example of a graphical representation of a visual output on a display to the referee by the referee system. Here, a more detailed functional status is displayed than that shown in FIG. 3. This more detailed representation shows each gamer or player of a team, and where each ear cup of each gamer is indicated with three separate symbols each representing status of a functional parameter, e.g. the three parameters P1, P2, P3 mentioned in the context of FIG. 1. The colour of each symbol indicates either OK status (e.g. green) or not OK status (e.g. red). In the example of FIG. 4, a circle and symbol “!” indicates that there is a functional problem with the gaming headset system of Player 2, and the colour of the parameter symbols indicate that one parameter at the left ear cup Player 2 is not OK. With such information of a functional problem, the referee can take action accordingly, e.g. judge if there is a technical problem or there is an attempt to cheat.

FIG. 5 shows an example of a layout of light indicators L1, L2, L3, L4 which can be place on an exterior surface of a headset, e.g. on a surface of each ear cup, to indicate a functional status of each of three parameters of the headset ear cup. The status can be indicated by the color of L1, L2, L3 (e.g. green for OK and red for not OK). Each light indicator L1, L2, L3 may indicate the status of the respective three parameters P1, P2, P3 mentioned in the context of FIG. 1. In case at least one parameter is not OK, then the surrounding light indicator L4 will indicate not OK, e.g. by a red colour, while L4 will indicate OK and indicate this by a green colour, if all three parameters are OK. Hereby, the headset itself indicates its functional status.

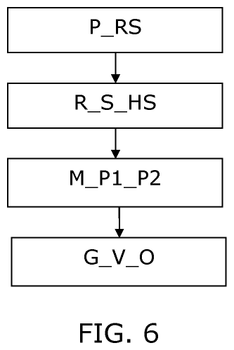

FIG. 6 illustrates steps of a preferred method for assisting a referee during an e-sport or a gaming event with a plurality of gamers, wherein each gamer has a gaming headset system for playing individual game audio signals to the gamers, the method comprising. First, providing P_RS a referee system connected to the gaming headset systems of all of the gamers. Recording sound R_S_HS captured by at least one microphone of all of the headsets, so as to allow the referee to later play back the sound to check for possible errors and attempts to cheat. Next, monitoring M_P1_P2 three parameters, of a functional status for each of the plurality of gaming headset systems by means of the referee system during the e-sport or gaming event. Finally, generating G_V_O, by the referee system, a visual output, such as an output signal to a display, so as to notify the referee of the e-sport or game event about the functional status of each of the gaming headset systems during the e-sport or gaming event, in response to said monitored at least two parameters for each of the plurality of gaming headsets.

To sum up, the invention provides an e-sport system for assisting an e-sport or gaming referee in detecting errors and attempts to cheat during an e-sport or gaming event. The system comprises gaming headset systems each comprising a headset to be worn by a gamer (GM), each headset having two ear cups each with a loudspeaker unit inside, an internal microphone inside at least one of the ear cups, and a mouth microphone serving to capture speech from the gamer wearing the headset. An ambient noise and speech suppression system (ANSS) serves to attenuate and suppress intelligibility of ambient speech sound reaching the gamer (GM) when wearing the headset, such as speech from the audience (AUD) or game commentator. The system further comprises a referee system (CNS) connected to the gaming headset systems. The referee system (RS) is configured to monitor at least two parameters of a functional status, preferably an audio functionality status, for each of the plurality of gaming headset systems. The referee system (RS) is generates a visual output, such as via a display, to notify the referee about the functional status of each of the plurality of gaming headset systems in response to said monitored parameters. This facilitates the task of the referee in identifying errors and attempts to cheat by the gamers, both which may potentially influence the outcome of the game.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1-55. (canceled)

56. An e-sport system comprising
a plurality of gaming headset systems each comprising
a headset to be worn by a gamer, wherein the headset comprises right and left ear cups each with a loudspeaker unit inside, an internal microphone inside at least one of the ear cups, and a mouth microphone serving to capture speech from the gamer wearing the headset, optionally also a feedforward microphone outside at least one of the ear cups, and
an ambient noise and speech suppression system arranged to attenuate and suppress intelligibility of ambient speech sound reaching the gamer when wearing the headset, and
a referee system arranged for connection to the plurality of gaming headset systems, wherein the referee system comprises
a processor configured to execute a control algorithm,
a display arranged to notify a referee of an e-sport event about a functional status of each of the plurality of gaming headset systems, and
a user interface configured to allow the referee to control a function of the referee system,
wherein the referee system is configured to monitor at least two parameters of the functional status for each of the plurality of gaming headset systems, and
wherein the referee system is configured to generate a visual output on the display, optionally also an audible output, to notify the referee about the functional status of each of the plurality of gaming headset systems in response to said monitored at least two parameters for each of the plurality of gaming headsets.

57. The e-sport system according to claim 56, wherein the referee system is configured to monitor a parameter indicative of a function of the ambient noise and speech suppression system for each of the plurality of gaming headset systems.

58. The e-sport system according to claim 56, wherein the referee system is configured to monitor at least three parameters of a functional status for each of the plurality of gaming headset systems.

59. The e-sport system according to claim 56, wherein the referee system is configured to generate a visual output comprising a graphical representation indicative of at least one of:
1) a parameter indicative of function of the mouth microphone for each of the plurality of gaming headset systems,
2) a function of the ambient noise and speech suppression system for each of the plurality of gaming headset systems, and
3) a parameter indicative of whether game sound is present in the headset for each of the plurality of gaming headset systems,
for all of the gaming headset systems.

60. The e-sport system according to claim 56, wherein the referee system is configured to notify a referee of an e-sport event if each of the plurality of gaming headset systems is functioning properly, by determining, if each of at least two parameters fulfil predetermined test criteria.

61. The e-sport system according to claim 56, wherein the referee system is configured to record audio captured by a microphone of a plurality of the gaming headset systems.

62. The e-sport system according to claim 61, wherein the referee system is configured to enable playback of the recorded audio from a selected one of the gaming headset systems, and wherein the referee system is configured to enable playback of the record audio at a selected time period from the selected one of the gaming headset systems.

63. The e-sport system according to claim 56, wherein the referee system is configured to monitor at least two parameters of a functional status for each of the plurality of gaming headset systems by receiving signals indicative of respective at least two parameter values determined at the respective gaming headset systems, wherein each of the gaming headset systems comprises a processor configured to execute a control algorithm arranged to determine a value indicative of effective acoustic insertion loss of the headset, and wherein each of the gaming headset systems is configured to transmit said value to the referee system.

64. The e-sport system according to claim 56, wherein the referee system is configured to determine a value indicative of effective acoustic insertion loss of the headset of each of the gaming headset systems.

65. The e-sport system according to claim 64, wherein the referee system is configured to determine the value indicative of effective acoustic insertion loss, for each of the gaming headset systems, based on an audio signal indicative of sound captured by an internal microphone and on an audio signal indicative of sound captured by a microphone positioned external to the ear cups.

66. The e-sport system according to claim 63, wherein the referee system is configured to determine, for each of the gaming headset systems, if the value indicative of the measured effective acoustic insertion loss is below a predetermined threshold level and to provide a visual indication to the referee in case said value for one or more of the gaming headset systems is below the predetermined threshold level.

67. The e-sport system according to claim 56, wherein each of the gaming headset systems comprises an active noise cancellation system, and wherein each of the gaming headset systems is configured to transmit a signal indicative of a function of the active noise cancellation system to the referee system.

68. The e-sport system according to claim 56, wherein the referee system comprises a camera.

69. The e-sport system according to claim 56, wherein the referee system is configured to execute a referee assisting algorithm configured to receive at least one signal from each of the gaming headset systems and to determine accordingly, for each of the gaming headset systems, if it likely that the gamer wearing the headset can hear sound that can be considered as cheat or fraud, and to initiate an action accordingly.

70. A method for assisting a referee during an e-sport or a gaming event with a plurality of gamers, wherein each gamer has a gaming headset system for playing individual game audio signals to the gamers, the method comprising
providing a referee system connected to the gaming headset systems of all of the gamers, wherein the referee system comprises
a processor configured to execute a control algorithm,
a display arranged to notify a referee of an e-sport event about a functional status of each of the plurality of gaming headset systems, and
a user interface configured to allow the referee to control a function of the referee system,
monitoring at least two parameters of a functional status for each of the plurality of gaming headset systems by means of the referee system during the e-sport or gaming event, and
generating, by the referee system, a visual output on the display so as to notify the referee about the functional status of each of the gaming headset systems during the e-sport or gaming event, in response to said monitored at least two parameters for each of the plurality of gaming headsets.
